(19) United States
(12) Patent Application Publication
(10) Pub. No.: US 2005/0091458 A1
(43) Pub. Date: Apr. 28, 2005

(54) Storage control apparatus, control system capable of DMA transfer, and method of controlling DMA transfer

(76) Inventors: Yumi Sato, Kanagawa (JP); Fumio Sudo, Kanagawa (JP); Yasumasa Nakada, Tokyo (JP)

Correspondence Address: DLA PIPER RUDNICK GRAY CARY US, LLP, 2000 UNIVERSITY AVENUE, E. PALO ALTO, CA, 94303-2248, US

(21) Appl. No.: 10/800,349

(22) Filed: Mar. 12, 2004

(30) Foreign Application Priority Data
Oct. 27, 2003 (JP) 2003-366460

(51) Int. Cl. G06F 12/08

(52) U.S. Cl. 711/138; 711/207; 711/203; 711/146; 710/22

(57) ABSTRACT

The present invention of a storage control apparatus which is connected to a host bus connected to a CPU (Central Processing Unit), a peripheral bus connected to at least one IP (Intellectual Property), and a system memory and controls DMA (Direct Memory Access) transfer from the IP to the system memory, having: an address map judgment section which judges whether an address given from one of the peripheral bus and the host bus indicates a memory area managed by the storage control apparatus in the system memory; a memory control section which controls data transfer to/from the system memory; a TLB (Translation Look-aside Buffer) information holding section which holds address information that indicates an area cacheable by the CPU; an address judgment section which judges on the basis of the address information held by the TLB information holding section whether the address given from one of the peripheral bus and the host bus indicates the area cacheable by the CPU; and a snoop address control section which, when it is judged on the basis of a judgment result from the address judgment section that the CPU needs to be notified of the address, executes notification through the host bus.

### CROSS REFERENCE TO RELATED APPLICATION

This application is based upon and claims benefit of priority under 35 USC 119 from the Japanese Patent Application No. 2003-366460, filed on Oct. 27, 2003, the entire contents of which are incorporated herein by reference.

### BACKGROUND OF THE INVENTION

The present invention relates to a storage control apparatus, a control system capable of DMA (Direct Memory Access) transfer, and a method of controlling DMA transfer and, more particularly, to an apparatus or system having a plurality of buses.

FIG. 10 shows the bus arrangement in a system on chip (to be referred to as an SoC hereinafter) serving as a conventional control system capable of DMA transfer.

Buses on an SoC 200 are separated into a high-speed host bus 101 to which a CPU (Central Processing Unit) 201 having a control section 202 and cache 203, a storage control apparatus 222, and an arbitrary number of IPs (Intellectual Properties) 211 are connected, and a low-speed peripheral bus 102 to which a plurality of IPs 212 to 214 are connected.

FIG. 10 shows one CPU 201, however, the system can have a plurality of CPUs.

The IPs 212 to 214 are various kinds of controllers having specific control functions, including, e.g., a controller related to interrupt processing and a controller related to an external interface.

The host bus 101 and peripheral bus 102 are connected through a bus bridge (or bus module) 221. Data transfer between the buses 101 and 102 can be executed through a buffer (FIFO) in the bus bridge 221.

A system memory 231 formed from a RAM is arranged outside the SoC 200. Most data transfer between the system memory 231 and the SoC 200 is executed between the CPU 201 and the system memory 231. The speed of data transfer between the CPU 201 and the system memory 231 is increased by connecting, to the host bus 101, the storage control apparatus (memory controller) 222 which controls the system memory 231.

The system memory 231 includes a normally non-cacheable (uncacheable) area 231a, an area 231b that is judged to be cacheable or non-cacheable by control information in an address translation table, a normally cacheable area 231c, and an address translation table 231d. Part of the address translation table 231d is stored in a TLB (Translation Look-aside Buffer) corresponding to a buffer that stores data necessary for translating a virtual address into a physical address, as will be described later.

In processing by the CPU 201, a virtual address is used. To access the host bus 101, a physical address is used. When the CPU 201 should access the system memory 231, translation from a virtual address into a physical address is necessary. The processing speed decreases if the translation table 231d on the system memory 231 is looked up for every access to the system memory 231. To prevent this, part of the translation table 231d is stored in the TLB provided in the CPU 201.

The structure of the TLB and the translation operation to the physical address will be described.

FIG. 11 shows an example of the address translation table.

An index is generated from a context ID (process ID) and a virtual page number (VPN).

For example, the OS (Operating System) allocates an area on the memory for each context ID. This information is managed by the OS.

The address in that area is decided by the virtual page number.

A physical page number (PPN) and control information corresponding to the virtual page number are stored here.

The generated index decides the physical page number and control information corresponding to the virtual page number. Whether the area is cacheable is judged on the basis of the control information.

Incidentally, the virtual page number is regarded as upper bits, the offset is regarded as lower bits, and the virtual address is generated by connecting the virtual page number and the offset. The physical page number is regarded as upper bits, the offset is regarded as lower bits, and the physical address is generated by connecting the physical page number and the offset.

FIG. 12 shows an example of the structure of the TLB.

The TLB translates a VPN (Virtual Page Number) into a PPN (Physical Page Number). Corresponding control information also contains information representing whether the area is cacheable or non-cacheable.

In a write through method, when the CPU 201 writes data in the system memory 231, it is updated simultaneously with cache to maintain the cache coherence.

However, when the IPs 211 to 214 directly access the system memory 231 without intervening the CPU 201, i.e., when DMA transfer is executed, the IPs 211 to 214 write data in only the system memory 231. For this reason, the coherence between the cache in the CPU 201 and the system memory 231 may be lost.

To prevent this, the CPU 201 executes snoop, i.e., monitors transactions on the bus. When data is written at an address to be cached, processing for invalidating corresponding data in the cache is executed to maintain the cache coherence.

References that disclose conventional storage control apparatuses are as follows.
International Publication No. 97/34228
Japanese Patent Publication No. 2938040
Japanese Patent Laid-Open No. 5-282197
Japanese Patent Laid-Open No. 2001-43204
Japanese Patent Laid-Open No. 11-85682

The conventional apparatuses however have the following problems about the usage of the host bus 101.

The conventional storage control apparatus 222 can determine whether a given address indicates an area in the system memory 231. However, the storage control apparatus cannot determine the following address map states.
(1) Whether the area is normally cacheable
(2) Whether the area is normally non-cacheable
(3) Whether the area is defined by the page table or TLB

In DMA transfer from the IPs 212 to 214 on the peripheral bus 102 to the system memory 231, if snoop is to be executed to maintain the cache coherence, the DMA transfer must be executed through the host bus 101 independently of whether the transfer destination address indicates a cache area. As a result, the usage of the host bus 101 increases.

In addition, in DMA transfer from the IPs 212 to 214 on the low-speed peripheral bus 102 to the storage control apparatus 222 on the high-speed host bus 101, transfer on the host bus 101 is restricted because the transfer rate of the peripheral bus 102 is lower than that of the host bus 101. This also causes an increase in usage of the host bus 101.

As described above, conventionally, in the system having the plurality of buses, DMA transfer from an IP connected to the low-speed peripheral bus to the system memory is always executed through the high-speed host bus connected to the CPU, resulting in an increase in usage of the host bus.

### SUMMARY OF THE INVENTION

According to one aspect of the present invention, there is provided a storage control apparatus which is connected to a host bus connected to a CPU (Central Processing Unit), a peripheral bus connected to at least one IP (Intellectual Property), and a system memory and controls DMA (Direct Memory Access) transfer from the IP to the system memory, comprising:
an address map judgment section which judges whether an address given from one of the peripheral bus and the host bus indicates a memory area managed by the storage control apparatus in the system memory;
a memory control section which controls data transfer to/from the system memory;
a TLB (Translation Look-aside Buffer) information holding section which holds address information that indicates an area cacheable by the CPU;
an address judgment section which judges on the basis of the address information held by the TLB information holding section whether the address given from one of the peripheral bus and the host bus indicates the area cacheable by the CPU; and
a snoop address control section which, when it is judged on the basis of a judgment result from the address judgment section that the CPU needs to be notified of the address, executes notification through the host bus.

According to one aspect of the present invention, there is provided a control system capable of DMA transfer, comprising:
a CPU connected to a host bus;
at least one IP connected to one of the host bus and a peripheral bus;
a system memory accessible by one of said CPU and said IP; and
a storage control apparatus which is connected to the host bus, the peripheral bus, and said system memory and controls DMA transfer from said IP to said system memory,
said storage control apparatus comprising
an address map judgment section which judges whether an address given from one of the peripheral bus and the host bus indicates a memory area managed by said storage control apparatus in said system memory,
a memory control section which controls data transfer to/from said system memory,
a TLB information holding section which holds address information that indicates an area cacheable by said CPU,
an address judgment section which judges on the basis of the address information held by said TLB information holding section whether the address given from one of the peripheral bus and the host bus indicates the area cacheable by said CPU, and
a snoop address control section which, when it is judged on the basis of a judgment result from said address judgment section that said CPU needs to be notified of the address, executes notification through the host bus.

According to one aspect of the present invention, there is provided a method of controlling DMA transfer in a system comprising
a CPU connected to a host bus,
at least one IP connected to one of the host bus and a peripheral bus,
a system memory accessible by one of the CPU and the IP, and
a storage control apparatus which is connected to the host bus, the peripheral bus, and the system memory and controls DMA transfer from the IP to the system memory, comprising:
judging whether an address given from one of the peripheral bus and the host bus indicates a memory area managed by the storage control apparatus in the system memory;
when the address is in the memory area, judging on the basis of address information that indicates an area cacheable by the CPU whether the address given from one of the peripheral bus and the host bus indicates the area cacheable by the CPU; and
when it is judged on the basis of a judgment result that the CPU needs to be notified of the address, executing notification through the host bus.

### BRIEF DESCRIPTION OF THE DRAWINGS

FIG. 1 is a block diagram showing the arrangement of a storage control apparatus according to the first embodiment of the present invention;

FIG. 2 is a block diagram showing the bus arrangement in an entire system having the storage control apparatus;

FIG. 3 is an explanatory view showing the memory map in the system;

FIG. 4 is a timing chart showing changes in the waveforms of an address, data, and a write signal on the host bus in pseudo write transaction in the system;

FIG. 5 is a timing chart showing changes in the waveforms of an address, data, and a write signal on the peripheral bus in pseudo write transaction in the system;

FIG. 6 is a block diagram showing the arrangement of a storage control apparatus according to the second embodiment of the present invention;

FIG. 7 is a block diagram showing the bus arrangement in an entire system having the storage control apparatus;

FIG. 8 is a block diagram showing the arrangement of a storage control apparatus according to the third embodiment of the present invention;

FIG. 9 is a timing chart showing changes in the waveforms of addresses, data, and write signals on the host bus and peripheral bus in pseudo write transaction in a system including the storage control apparatus according to the third embodiment of the present invention;

FIG. 10 is a block diagram showing the bus arrangement in an entire system having a conventional storage control apparatus;

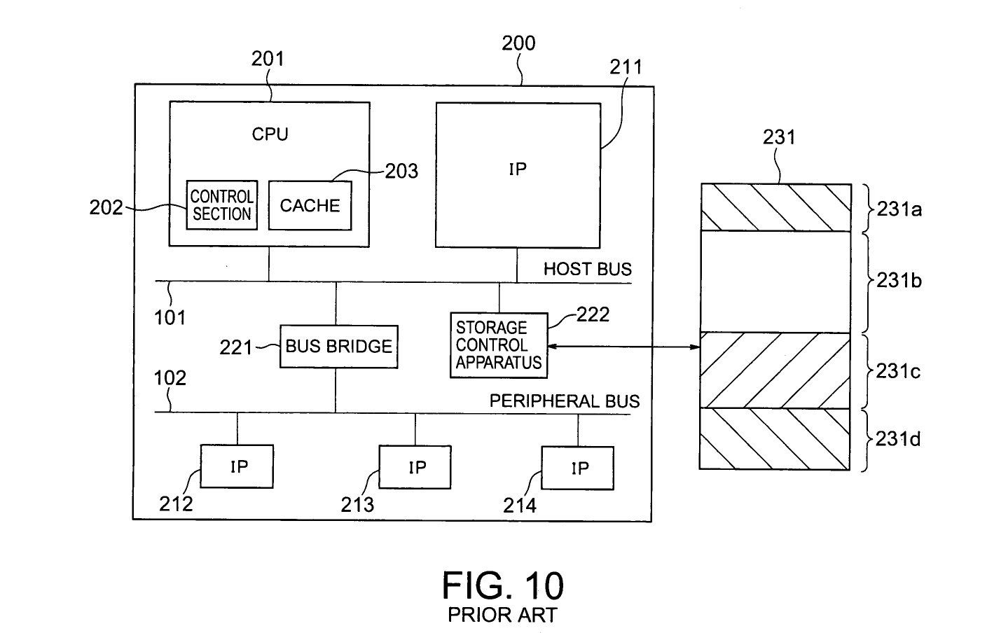

FIG. 11 is an explanatory view showing an address translation table to be used to translate a virtual address into a physical address; and

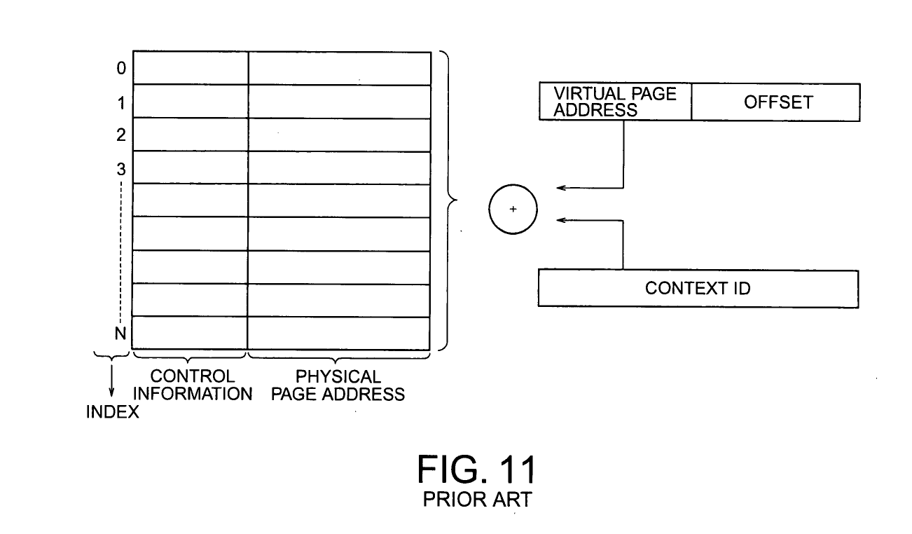

FIG. 12 is an explanatory view showing the structure of a TLB to be used for address translation.

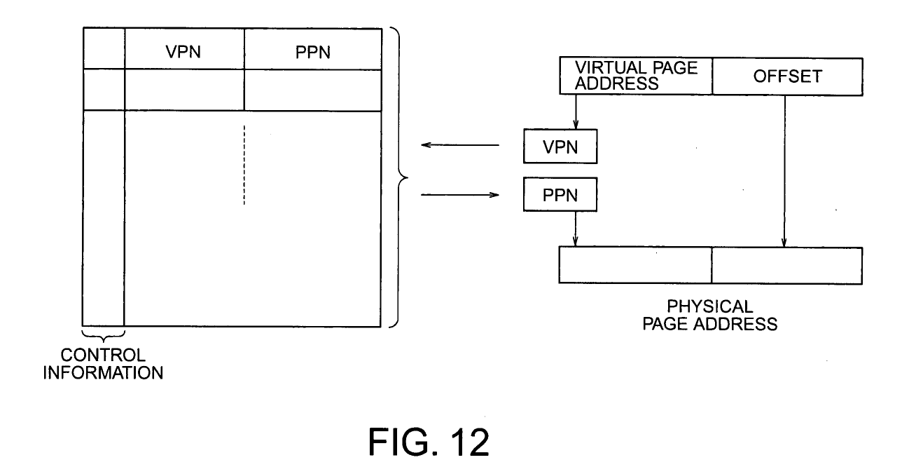

### DESCRIPTION OF THE PREFERRED EMBODIMENTS

The embodiments of the present invention will be described below with reference to the accompanying drawings.

The embodiments to be described later are designed to determine first whether an address sent from a host bus or peripheral bus corresponds to an area managed by the storage control apparatus and whether the address indicates an area cacheable by the CPU. Except when the area is uncacheable, the storage control apparatus notifies the CPU of the address to show the area accessed by the IP so as to ensure the cache coherence.

(1) First Embodiment

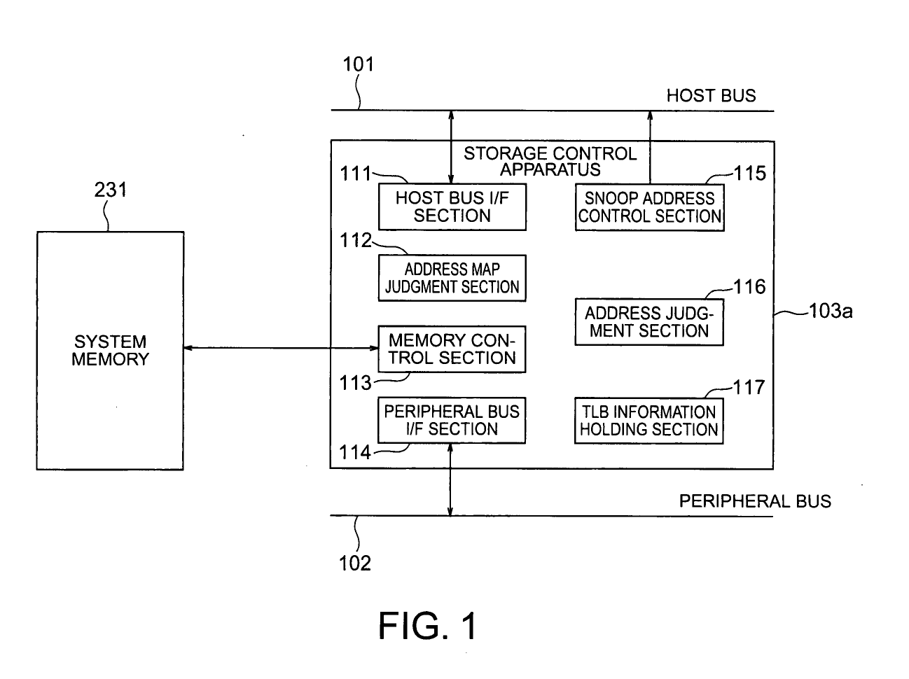

FIG. 1 shows the arrangement of a storage control apparatus according to the first embodiment.

A storage control apparatus 103a comprises a host bus I/F section 111 and snoop address control section 115 which are connected to a host bus 101, an address map judgment section 112, a memory control section 113, an address judgment section 116, a TLB information holding section 117, and a peripheral bus I/F section 114 connected to a peripheral bus 102. Especially, as a characteristic feature, this apparatus comprises the peripheral bus I/F section 114, snoop address control section 115, address judgment section 116, and TLB information holding section 117.

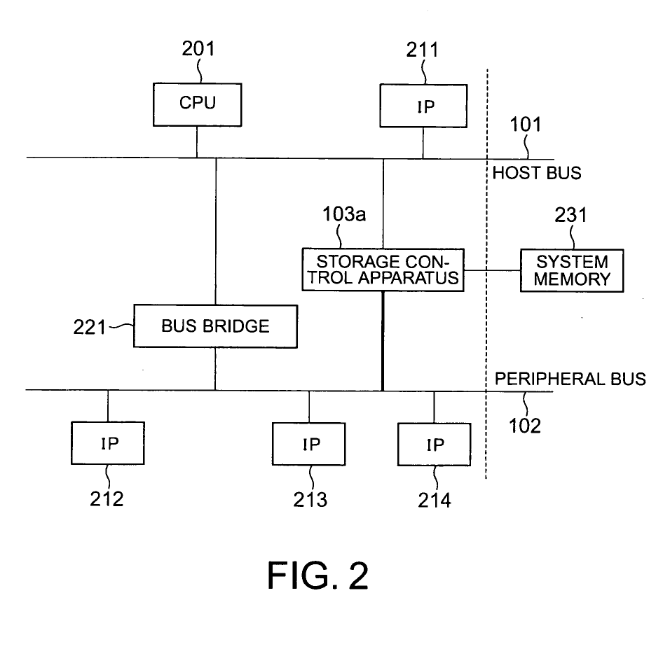

FIG. 2 shows an example of the arrangement of an entire system including the storage control apparatus 103a. This system is different from the prior art in that the storage control apparatus 103a is connected not only to the host bus 101 but also to the peripheral bus 102.

A CPU 201 is assumed to employ a write through method.

The functions of the blocks in the storage control apparatus 103a are as follows.

(1) Host Bus I/F Section 111

The host bus I/F section 111 controls bus access between the host bus 101 and the storage control apparatus 103a.

(2) Address Map Judgment Section 112

The address map judgment section 112 judges whether an address (physical address) on the host bus 101 or peripheral bus 102 indicates a system memory 231 managed by the storage control apparatus.

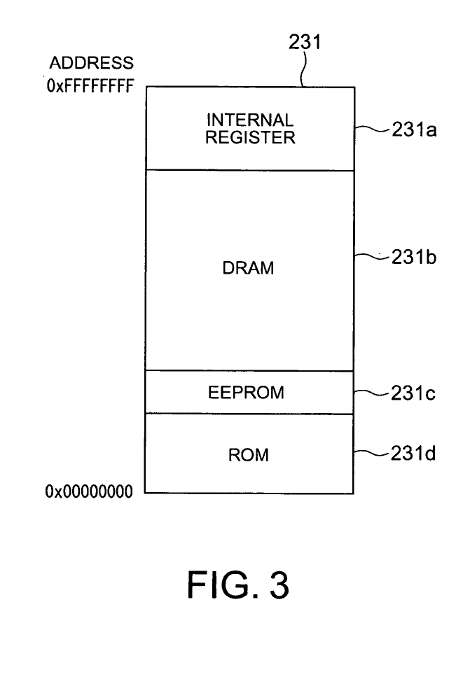

For example, when the storage control apparatus 103a is a DRAM controller, the address map judgment section 112 judges whether an address on the host bus 101 or peripheral bus 102 is an address allocated to a DRAM 231b managed by the DRAM controller in the system memory 231 formed from a memory map having an internal register 231a, DRAM 231b, EEPROM 231c, and ROM 231d as shown in FIG. 3.

(3) Memory Control Section 113

The memory control section 113 controls access to the system memory 231.

When the address map judgment section 112 judges that the address indicates a memory area (DRAM 231b) managed by the storage control apparatus, the memory control section 113 controls memory access in accordance with an access request (read/write) on the bus.

(4) Peripheral Bus I/F Section 114

The peripheral bus I/F section 114 controls bus access between the peripheral bus 102 and the storage control apparatus 103a.

(5) TLB Information Holding Section 117

The TLB information holding section 117 holds virtual/physical address translation information and control information (cacheable/non-cacheable judgment information) as copy information of the TLB of the CPU 201 necessary for address translation.

(6) Snoop Address Control Section 115

The snoop address control section 115 outputs a snoop address to the host bus 101.

When the judgment result sent from the address judgment section 116 does not indicate a non-cacheable area, the snoop address control section 115 broadcasts address invalidation transaction or DMA from a pseudo I/O to the system memory 231 onto the host bus 101.

This processing assumes that at least one CPU is present on the host bus 101 and is executed to notify all CPUs that the cache data of the address should be invalidated without specifying the transmission destination.

(7) Address Judgment Section 116

The address judgment section 116 judges whether an address on the host bus 101 or peripheral bus 102 is cacheable. If the addresses coincide, the address judgment section 116 notifies the snoop address control section 115 of it.

The address judgment section 116 judges whether an address on the host bus 101 or peripheral bus 102 is cacheable on the basis of the state of the preset address map unique to the system and the control information in the TLB information holding section 117.

Criteria are as follows.

1) Hit and cacheable: the snoop address control section 115 is notified of it.

2) Hit and non-cacheable: the snoop address control section 115 is not notified of it.

3) Miss: the snoop address control section 115 is notified of it.

Although the processing 3) may be a wasteful flow, it is executed for the sake of safety.

When a copy is present in the cache, the snoop address control section 115 is notified of all potential addresses.

The operation in this embodiment having the above arrangement will be described.

In DMA transfer from IPs 212 to 214 on the peripheral bus 102 to the system memory 231, judgment about whether snoop should be executed is done in the following way.

When the address map judgment section 112 judges that the address on the host bus 101 or peripheral bus 102 indicates access to the system memory 231 managed by the storage control apparatus, the address judgment section 116 judges first whether
1) the address on the peripheral bus 102 is
   A) an address in an normally cacheable area,
   B) an address that is normally non-cacheable, or
   C) an address that is controlled by control information in the address translation table.
2) When C) (an address that is controlled by control information in the address translation table) holds, the address on the peripheral bus 102 is compared with all physical addresses held by the TLB information holding section 117 to determine whether
   D) a physical address that coincides is present in the TLB information holding section 117 (i.e., TLB hit), or
   E) no physical address that coincides is present in the TLB information holding section 117 (i.e., TLB miss).

As described above, the TLB information holding section 117 holds only partial information of the address translation table. For this reason, in case of TLB miss, it cannot be judged whether the address is cacheable without looking up the address translation table on the system memory 231. In this embodiment, except when the address is obviously non-cacheable, a snoop operation is executed. Although this operation may be a wasteful flow, it is executed for the sake of safety.
3) When D) (a physical address that coincides is present in the TLB information holding section 117) holds, it is judged on the basis of the control information of the coinciding physical address held in the TLB information holding section 117 whether the address is
   F) cacheable or
   G) non-cacheable.
4) When the judgment result is B) (an address that is normally non-cacheable) or G) (a non-cacheable address), it is obvious that no data corresponding to the address on the peripheral bus 102 is present in the cache. Hence, the snoop operation need not be executed.

Otherwise, data corresponding to this address may be present in the cache. The address judgment section 116 notifies the snoop address control section 115 that the snoop operation should be executed.
5) Except when the judgment result by the address judgment section is B) or G), the snoop address control section 115 acquires the bus use right of the host bus 101 from the CPU (or, a bus arbiter) 201 and executes pseudo write transaction for snoop.

The pseudo write transaction for snoop will be described. Normal write transaction has the following characteristic features.

a) Handshake is established by an access request from the master and a response from an access object to that request.

b) Write data transfer from the master is executed.

To the contrary, pseudo write transaction is processing for causing the snoop address control section 115 to notify the CPU 201 of an address necessary for snoop processing. This processing is different from normal bus transaction in the following points.

A) The storage control apparatus serves as a master and issues transaction.

B) Since the access object that should respond is the storage control apparatus 103a itself that has issued the transaction, no response is present. For this reason, no handshake is established by an access request issued from the storage control apparatus 103a and a response to the request.

If a response is necessary for complying with the bus protocol, handshake may apparently be established by causing the storage control apparatus 103a itself to issue a dummy response.

C) No valid data transfer is executed.

This is because the pseudo write transaction aims at notifying the CPU 201 of the address necessary for snoop processing, unlike normal bus transaction that aims at data transfer, and therefore, no data need be output onto the bus. When a dummy response is issued, the write in the DRAM is not executed.

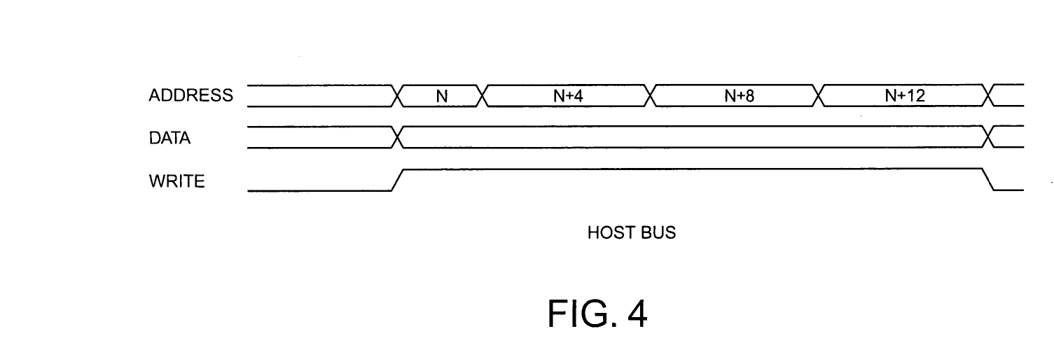

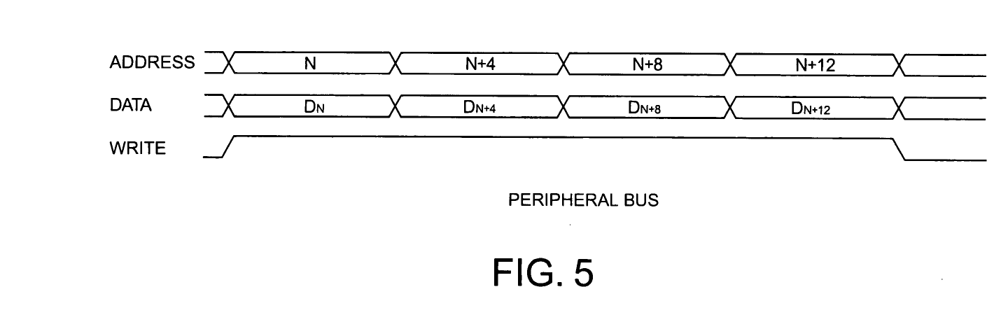

6) FIG. 4 shows changes in the waveforms of an address, data, and a write signal on the host bus 101 in pseudo write transaction. FIG. 5 shows changes in the waveforms of an address, data, and a write signal on the peripheral bus 102.

As shown in FIG. 5, when a DMA transfer request for the system memory 231 is sent from one of the IPs 212 to 214 on the peripheral bus 102 to the storage control apparatus 103a, addresses N, N+4, N+8, and N+12, data D_{N}, D_{N+4}, D_{N+8}, and D_{N+12} corresponding to the addresses, and a write signal are sent to the storage control apparatus 103a.

When the address judgment section 116 judges that the addresses N to N+12 on the peripheral bus 102 are cacheable, the storage control apparatus 103a issues pseudo write transaction for snoop.

In this write transaction, only the addresses N, N+4, N+8, and N+12 that must be sent to the CPU 201 and the write signal are transferred onto the host bus 101 without data transfer, as shown in FIG. 4.

In this ways although no actual write processing is executed, pseudo transaction is executed to perform snoop without data transfer.

According to the storage control apparatus 103a of the first embodiment, when DMA transfer is to be executed from one of the IPs 212 to 214 connected to the peripheral bus 102 to the system memory 231, the address judgment section 116 executes judgment. If the address judgment section 116 judges that the DMA transfer is transfer to a non-cacheable area defined by the TLB, notification to the CPU is unnecessary, and transfer can be performed without using the host bus 101. As a result, the usage of the host bus 101 can be reduced.

(2) Second Embodiment

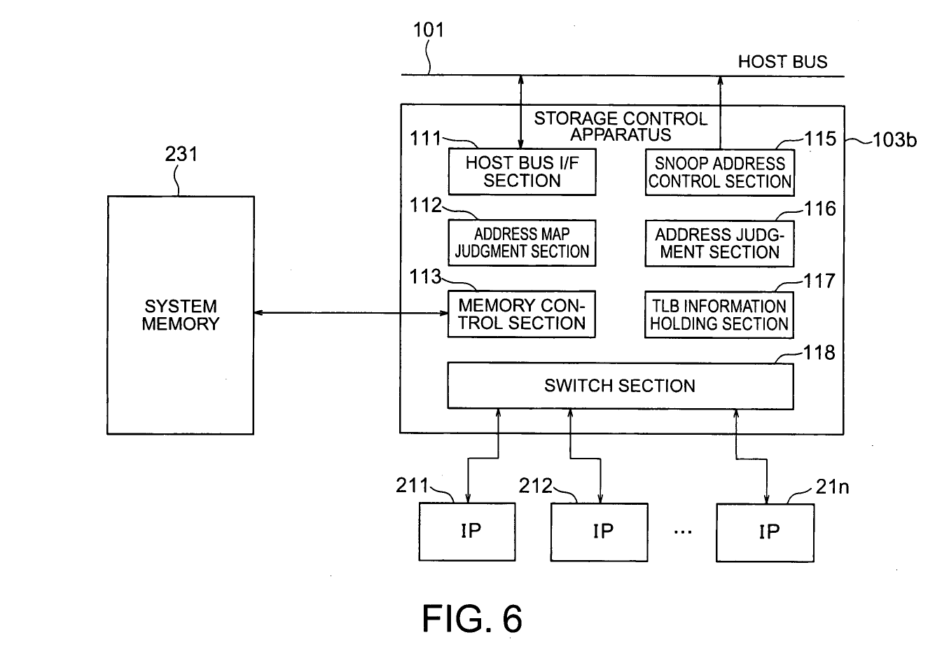

FIG. 6 shows the arrangement of a storage control apparatus 103b according to the second embodiment.

The storage control apparatus 103b according to the second embodiment has a switch section 118 in place of the peripheral bus I/F section 114 in the storage control apparatus 103a according to the first embodiment.

A host bus I/F section 111 of the second embodiment has a bus master function, as in the first embodiment.

An address judgment section 116 judges whether it is access to the cache area of a CPU 201.

The switch section 118 arbitrates access from a plurality of IPs 211 to 21n (n is an integer; n≧2) to a system memory 231 to select one of the IPs and controls transfer between the selected IP and the system memory 231. In this case, in data transfer between the switch section 118 and one of the IPs 211 to 21n, peer-to-peer connection is directly done without intervening a host bus 101 or peripheral bus 102.

The same reference numerals as in the first embodiment denote the same elements in FIG. 6, and a description thereof will be omitted.

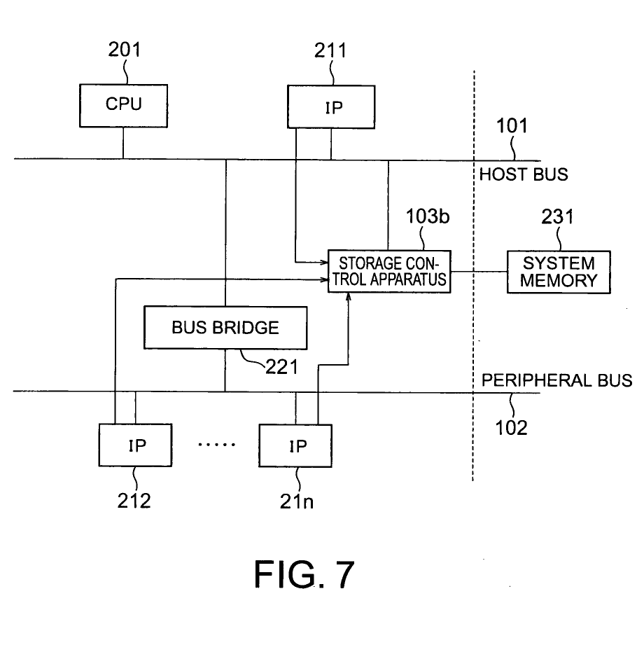

FIG. 7 shows the bus arrangement in a system including the storage control apparatus according to the second embodiment. The switch section 118 and IPs 211 to 21n in the storage control apparatus 103b are connected directly without intervening the host bus 101 or peripheral bus 102, as described above.

In the first embodiment, whether snoop is necessary is judged on the basis of an address on the host bus 101 or peripheral bus 102.

In the second embodiment, however, whether snoop is necessary is judged on the basis of not an address on the host bus 101 or peripheral bus 102 but an address directly sent from each of the IPs 211 to 21n.

The operation of judging in the second embodiment whether snoop is to be executed is the same as in the first embodiment. As in the first embodiment, the usage of the host bus 101 can be reduced.

(3) Third Embodiment

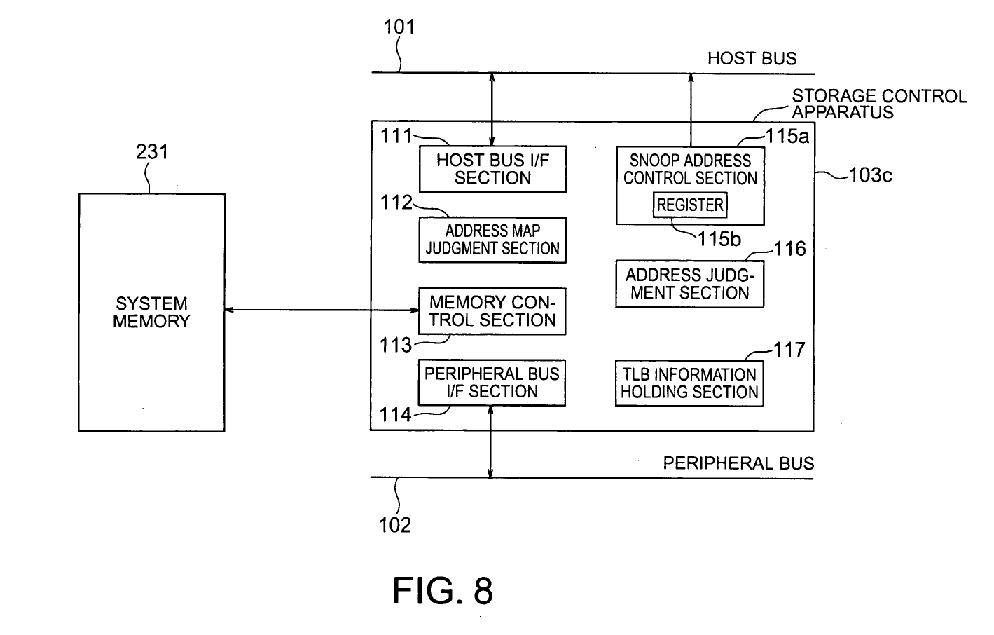

A storage control apparatus according to the third embodiment of the present invention will be described with reference to FIG. 8 that shows its arrangement.

A storage control apparatus 103c according to the third embodiment is different from the storage control apparatus 103a of the first embodiment in that a snoop address control section 115a has a register 115b.

An example of the arrangement of an entire system including the storage control apparatus 103c is the same as that of the first embodiment that has been described with reference to FIG. 2, and a description thereof will be omitted.

In the third embodiment, when addresses for which pseudo transaction necessary for snoop must be executed should be burst-transferred to a host bus 101, the addresses are stored in the register 115b. When both of the following two conditions are met, the snoop address control section 115a burst-transfers the addresses to the host bus 101.
1) When the size of data stored in the memory has reached the burst size, and
2) When the address of the data stored in the memory is an address which is required to be noticed to the CPU 201.

In this case, the transactions can be merged in accordance with the maximum burst size of the host bus 101 independently of the burst size of a peripheral bus 102.

With this arrangement, transfer corresponding to the maximum burst size of the host bus 101 connected to a CPU 201 can be executed. In addition, the peripheral bus 102 need not be stopped before the storage control apparatus 103c acquires the use right of the host bus 101. Furthermore, the addresses must temporarily be stored for pseudo transaction for snoop. Hence, the transfer efficiency for addresses necessary for snoop can be increased.

When consecutive addresses corresponding to the maximum burst size of the host bus are issued from the peripheral bus, transfer on the host bus can be executed by using the maximum burst size on the host bus.

That is, several transactions of the peripheral bus can be issued on the host bus as one transaction.

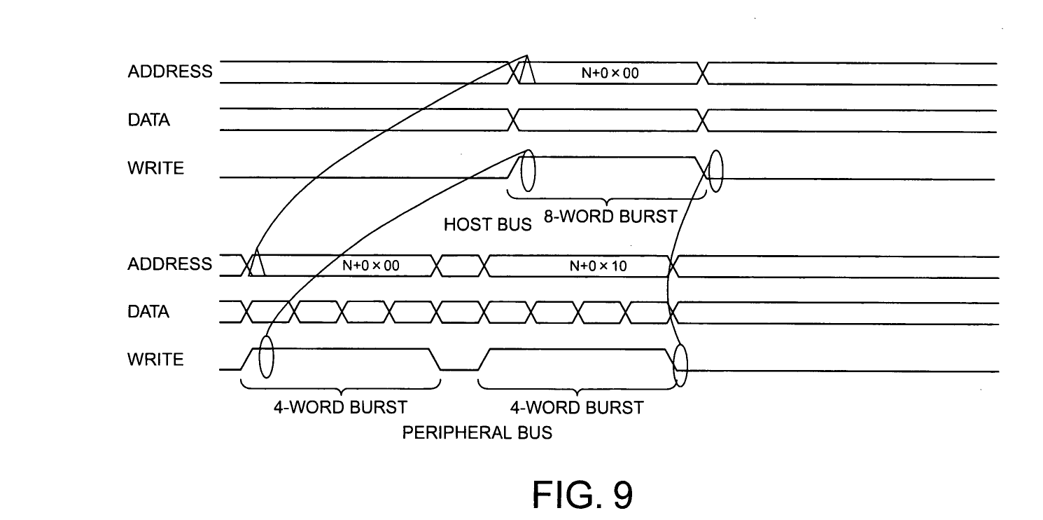

FIG. 9 is a timing chart of pseudo write transaction on the host bus 101 and peripheral bus 102 of the third embodiment.

On the peripheral bus 102, 4-word burst using N+0x00 as a start address is ended. Subsequently, when 4-word burst using N+0x10 as a start address starts, it can be judged that 8-word burst using N+0x00 as a start address can be executed on the host bus.

At this time, 8-word burst is started without effective data.

As soon as the storage control apparatus can be a bus master before the end of burst transfer of N+0x10, pseudo write transaction for snoop of 8-word burst can be executed. Accordingly, the usage of the host bus can be reduced.

Burst transfer addresses from the peripheral bus 102 are consecutive at a high probability. Hence, when the addresses are transferred as a bundle, the bus transfer efficiency increases.

According to the third embodiment, as in the first and second embodiments, when DMA transfer is to be executed from one of IPs 212 to 21n connected to the peripheral bus 102 to a system memory 231 through the storage control apparatus 103c, and the DMA transfer is transfer to a non-cacheable area defined by the TLB, an address judgment section 116 executes address judgment, as in the first and second embodiments. For this reason, DMA transfer can be implemented without using the host bus 101, and the usage of the host bus 101 can be reduced.

As described above, according to the storage control apparatuses of the above embodiments, in DMA transfer from an IP connected to the peripheral bus to the system memory, the address judgment section judges on the basis of information defined by the TLB whether the address indicates an area cacheable by the CPU. With this arrangement, DMA transfer can be executed without using the host bus. As a result, the usage of the host bus can be reduced.

The above-described embodiments are merely examples and do not limit the present invention. Various changes and modifications can be made within the technical scope of the present invention.

For example, FIGS. 2 and 7 show one CPU 201, however, each system can have a plurality of CPUs.

1. A storage control apparatus which is connected to a host bus connected to a CPU (Central Processing Unit), a peripheral bus connected to at least one IP (Intellectual Property), and a system memory and controls DMA (Direct Memory Access) transfer from the IP to the system memory, comprising:
an address map judgment section which judges whether an address given from one of the peripheral bus and said host bus indicates a memory area managed by said storage control apparatus in the system memory;
a memory control section which controls data transfer to/from the system memory;
a TLB (Translation Look-aside Buffer) information holding section which holds address information that indicates an area cacheable by the CPU;
an address judgment section which judges on the basis of the address information held by said TLB information holding section whether the address given from one of the peripheral bus and the host bus indicates the area cacheable by the CPU; and
a snoop address control section which, when it is judged on the basis of a judgment result from said address judgment section that the CPU needs to be notified of the address, executes notification through the host bus.

2. An apparatus according to claim 1, wherein when said address judgment section judges that the address indicates the cacheable area, said snoop address control section broadcasts a notification to invalidate cache data of the address onto the host bus.

3. An apparatus according to claim 1, wherein said snoop address control section has a storage section which stores addresses so as to burst-transfer the addresses to the host bus when a size of data indicated by the stored addresses has reached a burst size of the host bus.

4. An apparatus according to claim 3, wherein when said address judgment section judges that the address indicates the cacheable area, said snoop address control section broadcasts a notification to invalidate cache data of the address onto the host bus.

5. A control system capable of DMA transfer, comprising:
a CPU connected to a host bus;
at least one IP connected to one of the host bus and a peripheral bus;
a system memory accessible by one of said CPU and said IP; and
a storage control apparatus which is connected to the host bus, the peripheral bus, and said system memory and controls DMA transfer from said IP to said system memory,
said storage control apparatus comprising
an address map judgment section which judges whether an address given from one of the peripheral bus and the host bus indicates a memory area managed by said storage control apparatus in said system memory,
a memory control section which controls data transfer to/from said system memory,
a TLB information holding section which holds address information that indicates an area cacheable by said CPU,
an address judgment section which judges on the basis of the address information held by said TLB information holding section whether the address given from one of the peripheral bus and the host bus indicates the area cacheable by said CPU, and
a snoop address control section which, when it is judged on the basis of a judgment result from said address judgment section that said CPU needs to be notified of the address, executes notification through the host bus.

6. A system according to claim 5, wherein when said address judgment section judges that the address indicates the cacheable area, said snoop address control section broadcasts a notification to invalidate cache data of the address onto the host bus.

7. An system according to claim 5, wherein said snoop address control section has a storage section which stores addresses so as to burst-transfer the addresses to the host bus when the addresses corresponding to a burst size of the host bus are stored.

8. An system according to claim 7, wherein when said address judgment section judges that the address indicates the cacheable area, said snoop address control section broadcasts a notification to invalidate cache data of the address onto the host bus.

9. A method of controlling DMA transfer in a system comprising
a CPU connected to a host bus,
at least one IP connected to one of the host bus and a peripheral bus,
a system memory accessible by one of the CPU and the IP, and
a storage control apparatus which is connected to the host bus, the peripheral bus, and the system memory and controls DMA transfer from the IP to the system memory, comprising:
judging whether an address given from one of the peripheral bus and the host bus indicates a memory area managed by the storage control apparatus in the system memory;
when the address is in the memory area, judging on the basis of address information that indicates an area cacheable by the CPU whether the address given from one of the peripheral bus and the host bus indicates the area cacheable by the CPU; and
when it is judged on the basis of a judgment result that the CPU needs to be notified of the address, executing notification through the host bus.

10. A method according to claim 9, wherein when said address judgment section judges that the address indicates the cacheable area, said snoop address control section broadcasts a notification to invalidate cache data of the address onto the host bus.

11. A method according to claim 9, wherein said snoop address control section has a storage section which stores addresses so as to burst-transfer the addresses to the host bus when the addresses corresponding to a burst size of the host bus are stored.

12. A method according to claim 11, wherein when said address judgment section judges that the address indicates the cacheable area, said snoop address control section broadcasts a notification to invalidate cache data of the address onto the host bus.
